(19) United States
(12) Patent Application Publication
(10) Pub. No.: US 2021/0103515 A1
(43) Pub. Date: Apr. 8, 2021

(54) METHOD OF DETECTING USER INTERFACE LAYOUT ISSUES FOR WEB APPLICATIONS

(71) Applicant: Citrix Systems, Inc., Fort Lauderdale, FL (US)

(72) Inventors: Tianze Jiang, Nanjing City (CN); Maowen Li, Nanjing (CN); Taodong Lu, Nanjing (CN)

(21) Appl. No.: 16/462,724

(22) PCT Filed: Dec. 10, 2018
(86) PCT No.: PCT/CN2018/120070

§ 371 Date: May 21, 2019

(51) Int. Cl. G06F 11/36; G06F 40/14

(52) U.S. Cl. CPC G06F 11/3688; G06F 40/14; G06F 11/3664

(57) ABSTRACT

Techniques for detecting UI layout issues for web applications. The techniques include injecting a detection script into code of a target webpage, and executing the detection script to analyze and/or detect layout issues pertaining to UI elements of the target webpage. The techniques include recursively traversing nodes of a DOM tree of the target webpage. Based on the type of UI layout issue being analyzed and/or detected by the detection script, the recursive traversal of the DOM tree nodes can encompass all levels of the DOM tree or be limited to less than all levels of the DOM tree. By recursively traversing all levels or less than all levels of the DOM tree based on the type of UI layout issues being analyzed and/or detected by the detection script, the techniques can reduce processing resource requirements while decreasing the occurrence of missed UI layout issues in the target webpage.

### BACKGROUND

Web pages are documents on the World Wide Web that can be located, retrieved, and displayed in web browsers running on computers and/or mobile devices. Such web pages are written in the hypertext markup language (HTML), and have user interface (UI) presentations described using the cascading style sheet (CSS) language, which is typically used to describe the look-and-feel of web pages written in HTML. The CSS language enables webpage content to be separated from descriptions of UI presentations, which include information relating to UI elements such as images, video, text, etc. Using the CSS language, complex web pages are formatted on the fly, allowing the look-and-feel of the web pages to vary while the webpage content remains unchanged.

### SUMMARY

Web pages that have user interface (UI) presentations described using the cascading style sheet (CSS) language can pose particular challenges to software engineers, particularly those working in test environments. Whereas early webpage designs typically included arrangements of UI elements statically encoded in the webpage, today's complex webpage designs can include multilayered navigable collections of UI elements (e.g., images, video, text, etc.), which can be both statically and dynamically determined. As such, the detection of UI layout issues (e.g., overlap issues, truncation issues, etc.) in today's complex webpage designs has become increasingly difficult, often resulting in missed issues and/or false positive indications of issues.

Techniques are disclosed herein for detecting user interface (UI) layout issues for web applications. The disclosed techniques can include loading a target webpage to a web browser running on a client computer, injecting a detection script into code of the target webpage, and executing the detection script to analyze and/or detect one or more layout issues (e.g., overlap issues, truncation issues, etc.) pertaining to UI elements in the target webpage. The disclosed techniques can further include performing, by execution of the detection script, a recursive traversal of nodes of a document object model (DOM) tree corresponding to the target webpage. Based on the type of UI layout issues being analyzed and/or detected by the detection script, the recursive traversal of the DOM tree nodes can encompass all levels of the DOM tree or be limited to less than all levels of the DOM tree. Having performed the recursive traversal of the DOM tree nodes, the disclosed techniques can further include generating a suspect element list, which can list one or more UI elements in the target webpage for which a layout issue was detected. Once the suspect element list is generated, the disclosed techniques can further include performing a filtering process to remove false positive indications of UI layout issues from the suspect element list. Having removed the false positive indications from the suspect element list, the disclosed techniques can further include generating a client report of UI layout issues for the target webpage. By recursively traversing all levels of the DOM tree of the target webpage or less than all levels of the DOM tree based on the type of UI layout issues being analyzed and/or detected by the detection script, the disclosed techniques can advantageously reduce processing resource requirements while decreasing the occurrence of missed UI layout issues in the target webpage.

In one embodiment, a method of detecting user interface (UI) layout issues for web applications includes loading a target webpage to a web browser running on a client computer, and injecting a detection script into code of the target webpage. The method further includes executing the detection script to perform analysis and/or detection of UI layout issues pertaining to UI elements in the target webpage, in which the executing of the detection script includes (i) performing a recursive traversal of nodes of a document object model (DOM) of the target webpage, in which the nodes include at least structure information for rendering the respective UI elements in the target webpage, and, (ii) while performing the recursive traversal of nodes of the DOM, analyzing the structure information for one or more pairs of UI elements in the target webpage to detect one or more UI layout issues pertaining to the pairs of UI elements in the target webpage. The method further includes, having detected the UI layout issues pertaining to the pairs of UI elements, automatically generating, in a client report, one or more suggestions for modifying at least some of the structure information to address one or more of the UI layout issues, and terminating the recursive traversal of nodes of the DOM of the target webpage.

In certain arrangements, the UI layout issues include one or more overlap layout issues, and the analyzing of the structure information for one or more pairs of UI elements in the target webpage includes analyzing the structure information included in one or more nodes at an intermediate level of the DOM to detect the overlap layout issues pertaining to the pairs of UI elements in the target webpage.

In certain arrangements, the pairs of UI elements include a respective pair having a first UI element and a second UI element, and the overlap layout issues include a respective overlap layout issue pertaining to the first UI element overlapping and completely covering the second UI element. In addition, the terminating of the recursive traversal of nodes of the DOM of the target webpage includes, having detected the respective overlap layout issue pertaining to the first UI element overlapping and completely covering the second UI element, terminating the recursive traversal of nodes of the DOM for detecting UI layout issues pertaining to the first and second UI elements at the intermediate level of the DOM, due to the respective overlap layout issue not being problematic in the target webpage.

In certain arrangements, the pairs of UI elements include a respective pair having a first UI element and a second UI element, and the overlap layout issues include a respective overlap layout issue pertaining to the first UI element overlapping and partially covering the second UI element. The method further includes, having detected the respective overlap layout issue pertaining to the first UI element overlapping and partially covering the second UI element, continuing the recursive traversal of nodes of the DOM for detecting UI layout issues pertaining to the first and second UI elements to at least another level beyond the intermediate level of the DOM.

In certain arrangements, the terminating of the recursive traversal of nodes of the DOM of the target webpage includes, having detected the respective overlap layout issue pertaining to the first UI element overlapping and partially covering the second UI element, terminating the recursive traversal of nodes of the DOM for detecting UI layout issues pertaining to the first and second UI elements at the other level beyond the intermediate level of the DOM.

In certain arrangements, the UI layout issues include one or more truncation layout issues, and the analyzing of the structure information for one or more pairs of UI elements in the target webpage includes analyzing the structure information included in one or more nodes at an intermediate level of the DOM to detect the truncation layout issues pertaining to the pairs of UI elements in the target webpage.

In certain arrangements, the pairs of UI elements include a respective pair having a first UI element and a second UI element, the second UI element is a container element that contains the first UI element, and the truncation layout issues include a respective truncation layout issue pertaining to (i) a first width of the first UI element being longer than a second width of the second UI element, and (ii) a portion of the first UT element being hidden from view within the second UI element. The method further includes, having detected the respective truncation layout issue pertaining to the first UI element and the second UI element, continuing the recursive traversal of nodes of the DOM for detecting UI layout issues pertaining to the first and second UI elements to at least another level beyond the intermediate level of the DOM.

In certain arrangements, the terminating of the recursive traversal of nodes of the DOM of the target webpage includes, having detected the respective truncation layout issue pertaining to the first UI element and the second UI element, terminating the recursive traversal of nodes of the DOM for detecting UI layout issues pertaining to the first and second UI elements at the other level beyond the intermediate level of the DOM.

In a further embodiment, a system for detecting user interface (UI) layout issues for web applications includes a memory, and processing circuitry configured to execute instructions out of the memory (i) to load a target webpage to a web browser, (ii) to inject a detection script into code of the target webpage, (iii) to execute the detection script to perform analysis and/or detection of UI layout issues pertaining to UI elements in the target webpage, in which the execution of the detection script includes (a) performing a recursive traversal of nodes of a document object model (DOM) of the target webpage, the nodes including at least structure information for rendering the respective UI elements in the target webpage, and, (b) while performing the recursive traversal of nodes of the DOM, analyzing the structure information for one or more pairs of UI elements in the target webpage to detect one or more UI layout issues pertaining to the pairs of UI elements in the target webpage, and, (iv) having detected the UI layout issues pertaining to the pairs of UI elements, to automatically generate, in a client report, one or more suggestions for modifying at least some of the structure information to address one or more of the UI layout issues, and to terminate the recursive traversal of nodes of the DOM of the target webpage.

In another embodiment, a computer program product includes non-transitory, computer-readable media having instructions that, when executed by processing circuitry of a computerized apparatus, cause the processing circuitry to perform a method of detecting user interface (UI) layout issues for web applications. The method includes (i) loading a target webpage to a web browser running on a client computer, (ii) injecting a detection script into code of the target webpage, (iii) executing the detection script to perform analysis and/or detection of UI layout issues pertaining to UI elements in the target webpage, including (a) performing a recursive traversal of nodes of a document object model (DOM) of the target webpage, in which the nodes include at least structure information for rendering the respective UI elements in the target webpage, and, (b) while performing the recursive traversal of nodes of the DOM, analyzing the structure information for one or more pairs of UI elements in the target webpage to detect one or more UI layout issues pertaining to the pairs of UI elements in the target webpage, and, (iv) having detected the UI layout issues pertaining to the pairs of UI elements, automatically generating, in a client report, one or more suggestions for modifying at least some of the structure information to address one or more of the UI layout issues, and terminating the recursive traversal of nodes of the DOM of the target webpage.

Other functions and aspects of the claimed features of this disclosure will be evident from the Detailed Description that follows.

### BRIEF DESCRIPTION OF THE DRAWINGS

The foregoing and other objects, features, and advantages will be apparent from the following description of particular embodiments of the disclosure, as illustrated in the accompanying drawings, in which like reference characters refer to the same parts throughout the different views.

FIG. 1 is a block diagram of an exemplary test environment in which techniques may be practiced for detecting user interface (UI) layout issues for web applications;

FIG. 2a is an illustration of an exemplary webpage having UI layout issues that may be detected using the techniques of FIG. 1;

FIG. 2b is a block diagram of an illustrative example in which the techniques of FIG. 1 may be employed to detect the UI layout issues in the webpage of FIG. 2a;

FIG. 2c is a block diagram of an exemplary document object model (DOM) tree corresponding to the webpage of FIG. 2a;

FIG. 3a is a block diagram illustrating a UI layout overlap issue, in which a first exemplary UI element overlaps and completely covers a second exemplary UI element;

FIG. 3b is a block diagram illustrating another UI layout overlap issue, in which a third exemplary UI element overlaps and partially covers a fourth exemplary UI element; and

FIG. 4 is a flow diagram of an exemplary method of detecting UI layout issues for web applications.

### DETAILED DESCRIPTION

Techniques are disclosed herein for detecting user interface (UI) layout issues for web applications. The disclosed techniques can include injecting a detection script into code of a target webpage, and running the detection script to analyze and/or detect one or more layout issues pertaining to UI elements in the target webpage. The disclosed techniques can further include performing a recursive traversal of nodes of a document object model (DOM) tree corresponding to the target webpage. Based on the type of UI layout issues being analyzed and/or detected by the detection script, the traversal of the DOM tree nodes can encompass all levels of the DOM tree or be limited to less than all levels of the DOM tree. By recursively traversing all levels of the DOM tree of the target webpage or less than all levels of the DOM tree based on the type of UI layout issues being analyzed and/or detected by the detection script, the disclosed techniques can reduce processing resource requirements while decreasing the occurrence of missed UI layout issues in the target webpage.

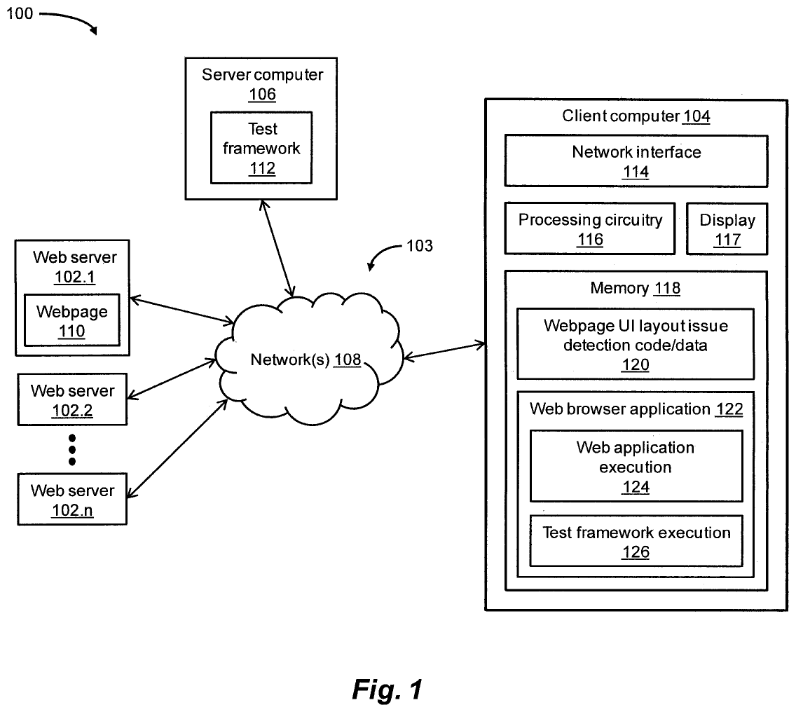

FIG. 1 depicts an illustrative embodiment of an exemplary test environment 100, in which techniques may be practiced for detecting user interface (UI) layout issues for web applications. As shown in FIG. 1, the test environment 100 can include one or more web servers 102.1, 102.2, . . . , 102.n, a client computer 104, and a server computer 106. The client computer 104 can include a network interface 114, processing circuitry 116, a display 117, and a memory 118. The network interface 114 can be configured to connect the client computer 104 to the respective web server(s) 102.1, . . . , 102.n and/or the server computer 106 via a communications medium 103, which can include one or more networks 108, such as one or more wired/wireless communications networks (e.g., local area network(s) (LAN(s)), metropolitan area network(s) (MAN(s)), wide area network(s) (WAN(s)), the Internet).

The memory 118 included in the client computer 104 can be configured with volatile storage (e.g., dynamic random access memory (DRAM), static random access memory (SRAM)) and/or non-volatile storage (e.g., magnetic memory, flash memory). The memory 118 can be further configured to store a variety of software constructs, including code/data for detecting webpage user interface (UI) layout issues 120, a web browser application 122 for executing a web application 124 and a specified test framework 124 for web applications, as well as an operating system, a document object model (DOM) tree generator, and/or any other suitable software construct. For example, the web application 124 may be any suitable computer-based software application or webpage (e.g., a webpage 110) hosted by the respective web server(s) 102.1, . . . , 102.n and accessible to the client computer 104 over the network(s) 108. Further, the test framework 126 may be any suitable test framework (e.g., a test framework 112) accessible to the client computer 104 over the network(s) 108 from the server computer 106, such as the Selenium® test framework for web applications.

The processing circuitry 116 included in the client computer 104 can be configured to operate in accordance with the various software constructs (e.g., the webpage UI layout issue detection code/data 120, the web browser application 122) stored in the memory 118. The processing circuitry 116 can be implemented in a variety of ways, using one or more processors running specialized software, one or more application specific integrated circuits (ASICs), one or more field programmable gate arrays (FPGAs), one or more discrete components, digital circuits, analog circuits, and so on, or any suitable combination thereof. The display 117 can be configured as any suitable computer display capable of visually displaying, to a user, complex web pages designed to include multilayered navigable collections of UI elements (e.g., images, video, text, etc.) statically and/or dynamically determined in the respective web pages.

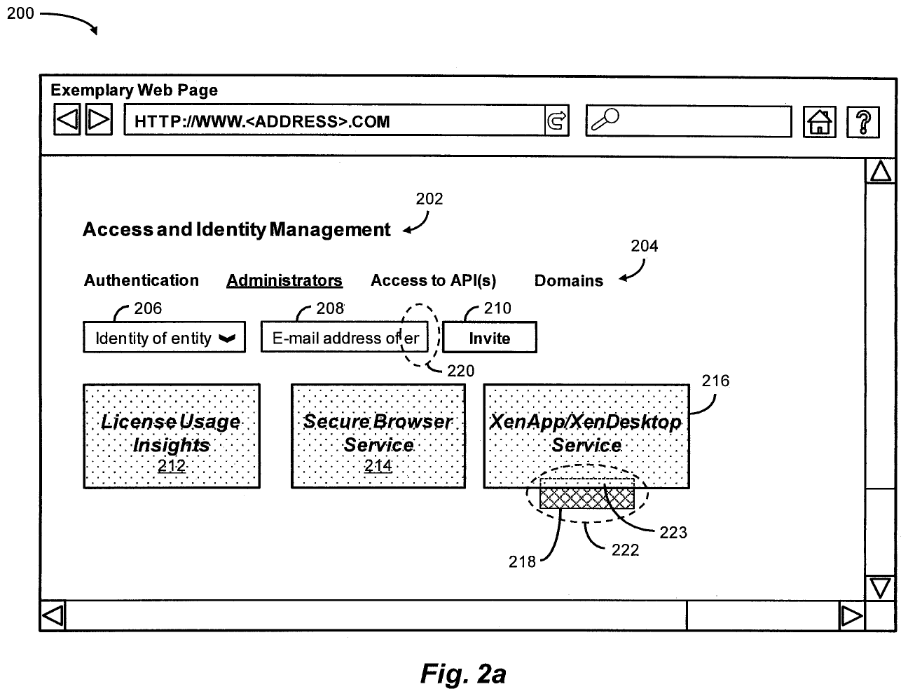

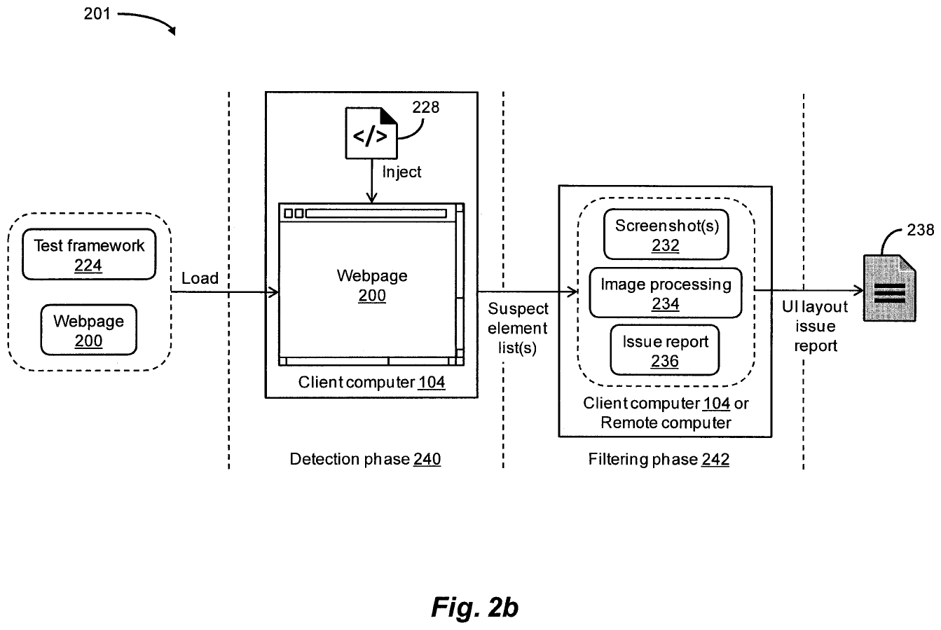

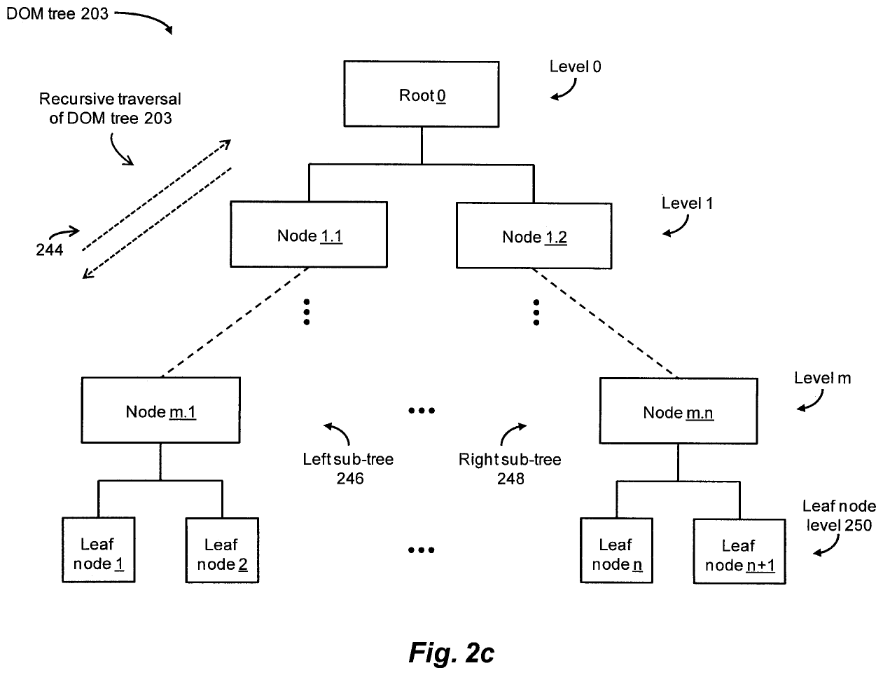

FIG. 2a depicts an exemplary webpage 200 that can be (i) hosted on a respective one of the web servers 102.1, . . . , 102.n, (ii) executed by the web browser application 122 running on the operating system of the client computer 104, and (iii) displayed on the display 117 of the client computer 104. As shown in FIG. 2a, the webpage 200 can include a number of UI elements, including a header element 202 indicating a subject or theme (e.g., “Access and Identity Management”) of the webpage 200, and multiple selectable elements 204 for accessing specified functions (e.g., “Authentication,” “Administrators,” “Access to API(s),” “Domains”) associated with the subject or theme of the webpage 200. As further shown in FIG. 2a, a label of the selectable element 204 corresponding to the “Administrators” function is underscored (e.g., “Administrators”), indicating that the Administrators function of the webpage 200 has been selected by the user, such as by using a mouse, a trackpad, a keyboard, or any other suitable input device of the client computer 104.

Once the Administrators function of the webpage 200 is selected by the user, a number of additional UI elements can appear for display on the webpage 200, including a drop-down menu 206, a box 208 containing a hyperlink or text, and a button 210 for performing a particular function or act, in which each of the hyperlink/text contained in the box 208 and the function/act performable via the button 210 corresponds to a user selection made from the drop-down menu 206. For example, the drop-down menu 206 may be employed by the user to select an identity or identifier of an administrator entity (“Identity of entity”), the box 208 may contain a hyperlink or text pertaining to an e-mail address of the selected administrator entity (“E-mail address of en . . . ”), and the button 210 may be actuated by the user (e.g., by using a mouse, a trackpad, a keyboard) to invite the selected administrator entity to join a business network or other suitable network of administrator entities.

As shown in FIG. 2a, the number of UI elements appearing on the webpage 200 upon user selection of the Administrators function (e.g., “Administrators”) can also include several additional selectable regions in the webpage 200, including selectable regions pertaining to license usage insights 212, a secure browser service 214, and a XenApp/XenDesktop service 216. It is noted that “XenApp” and “XenDesktop” are registered trademarks of Citrix Systems, Inc., Fort Lauderdale, Fla. USA for virtualization software products. For example, upon user actuation of the selectable regions 212, 214, 216, further functions or acts can be performed pertaining to license usage, browser services, and virtualization software product services, respectively, via the webpage 200. As further shown in FIG. 2a, the box 208 containing the hyperlink/text (“E-mail address of en . . . ”) may have a UI layout issue (i.e., a truncation issue) associated therewith, as indicated by reference numeral 220. In addition, the selectable region 216 (“XenApp/XenDesktop Service”) may also have a UI layout issue (i.e., an overlap issue involving another UI element 218) associated therewith, as indicated by reference numeral 222.

The techniques disclosed herein for detecting user interface (UI) layout issues for web applications can include loading the webpage 200 to the web browser application 122 (also referred to herein as the “browser”) running on the client computer 104, injecting a detection script into code of the webpage 200, and executing (or interpreting) the detection script to analyze and/or detect one or more layout issues (e.g., overlap issues, truncation issues, etc.) pertaining to UI elements in the webpage 200. The disclosed techniques can further include performing, by execution (or interpretation) of the detection script, a recursive traversal of nodes of a document object model (DOM) tree corresponding to the webpage 200. Based on the type of UI layout issues being analyzed and/or detected by the detection script, the recursive traversal of the DOM tree nodes can encompass all levels of the DOM tree or be limited to less than all levels of the DOM tree. Having performed the recursive traversal of the DOM tree nodes, the disclosed techniques can further include generating a suspect element list, which can list one or more UI elements in the webpage 200 for which a layout issue was detected. Once the suspect element list is generated, the disclosed techniques can further include performing a filtering process to remove false positive indications of UI layout issues from the suspect element list. Having removed the false positive indications from the suspect element list, the disclosed techniques can further include generating a client report of UI layout issues for the webpage 200. By recursively traversing all levels of the DOM tree of the webpage 200 or less than all levels of the DOM tree based on the type of UI layout issues being analyzed and/or detected by the detection script, the disclosed techniques can advantageously reduce processing resource requirements while decreasing the occurrence of missed UI layout issues in the webpage 200.

The disclosed techniques for detecting UI layout issues for web applications will be further understood with reference to the following illustrative example, as well as FIGS. 1 and 2a-2c. In this example, the detection of UI layout issues for the webpage 200 (such as the UI layout issues indicated by reference numerals 220, 222; see FIG. 2a) can be performed in two phases, namely, a detection phase 240 (see FIG. 2b) and a filtering phase 242 (see also FIG. 2b). The detection phase 240 can be performed to generate a suspect element list, which can list a number of detected UI layout issues for the webpage 200. The filtering phase 242 can be performed to receive the suspect element list generated during the detection phase 240, and to perform a filtering process to remove any false positive indications of layout issues from the suspect element list, thereby generating a client report 238 (see FIG. 2b) of UI layout issues for the webpage 200. As shown in FIG. 2b, the detection phase 240 can be performed by the client computer 104 (see FIG. 1) upon which the webpage 200 is being executed, while the filtering phase 242 can be performed by the client computer 104 or, alternatively, a remote computer.

In preparation for performing functions or acts pertaining to the detection phase 240 (see FIG. 2b), the client computer 104 loads the webpage 200 and a test framework 224 (e.g., the Selenium® test framework) to the browser 122 running on the client computer 104. For example, the browser 122 may be the Microsoft Internet Explorer® browser, the Apple Safari® browser, the Google Chrome™ browser, the Mozilla Firefox® browser, or any other suitable web browser application. Having loaded the webpage 200, the browser 122 executes the webpage 200, assigning positions (or locations) and/or dimensions (or sizes) (e.g., height, width) to the UI elements in the webpage 200 based on a document object model (also referred to herein as the “DOM” or “DOM tree”) and/or a cascading style sheet (CSS) for each node of the DOM tree. For example, the browser 122 may assign positions/dimensions to the respective elements 202, 204, 206, 208, 210, 212, 214, 216, 218 in the webpage 200, as illustrated in FIG. 2a.

It is noted that a document object model (DOM) is a cross-platform and language-independent convention for representing and/or interacting with objects of a webpage written in the hypertext markup language (HTML) or any other suitable markup language. Further, elements of a DOM, which correspond to individual components of the particular markup language used to write the webpage, can be represented as nodes of a DOM tree. For example, the DOM tree generator running on the operating system of the client computer 104 may generate a DOM tree 203 from objects of the webpage 200, as illustrated in FIG. 2c. It is further noted that the cascading style sheet (CSS) language can be used to describe style and/or format attributes (e.g., the look-and-feel) of a webpage written in HTML or any other suitable markup language. For example, the CSS language may be used to specify a CSS file containing the style and/or format attributes that describe the UI presentation of the webpage 200. Once the positions/dimensions are assigned to each UI element in the webpage 200 and the CSS file is specified describing the UI presentation of the webpage 200, the UI elements 202, 204, 206, 208, 210, 212, 214, 216, 218 in the webpage 200 can be rendered, via the browser 122, on the display 117 of the client computer 104.

Having loaded the webpage 200 and the test framework 224 to the browser 122, the client computer 104 performs the functions or acts pertaining to the detection phase 240 (see FIG. 2b). As illustrated in FIGS. 1, 2a, and 2b, the client computer 104 executes the code for detecting webpage UI layout issues 120, injecting a detection script 228 into code of the webpage 200 being executed in the browser 122. For example, the detection script 228 may be implemented using the JavaScript® programming language or any other suitable programming language. Further, the test framework 224 (e.g., the Selenium® test framework) may be executed in the browser 122 to load a JavaScript® file containing the detection script 228 and to inject the detection script 228 into the code of the webpage 200, thereby allowing the detection script 228 to be executed together with the webpage code in the browser 122 of the client computer 104.

Once the detection script 228 is injected into the code of the webpage 200, the detection script 228 is executed to detect the layout issues (e.g., the truncation and overlap issues) pertaining to the UI elements in the webpage 200, as indicated by reference numerals 220, 222. To that end, the detection script 228 performs a recursive traversal of nodes of the DOM tree 203, encompassing either all levels of the DOM tree 203 or less than all levels of the DOM tree 203 based on the type of UI layout issues being detected by the detection script 228. For example, the detection script 228 may be executed to detect the “overlap” type of UI layout issues pertaining to the UI elements in the webpage 200. As shown in FIG. 2a, one such overlap issue (as indicated by reference numeral 222) involves an image of the selectable region of the XenApp/XenDesktop service 216, which overlaps a portion of another image of the UI element 218. To detect such overlap issues in the webpage 200, the detection script 228 can perform a recursive (e.g., top-down, bottom-up) traversal of the nodes of the DOM tree 203, as illustrated by directional arrows 244 (see FIG. 2c).

FIG. 2c depicts an illustrative embodiment of the DOM tree 203, which defines the relationships between data (or content) elements, formatting information, and/or positioning information used in rendering the webpage 200 on the display 117 of the client computer 104. As shown in FIG. 2c, the DOM tree 203 can include a left sub-tree 246 and a right sub-tree 248, as well as a plurality of levels ranging from “Level 0” to “Level m.” Level 0 of the DOM tree 203 can include a root node “0,” intermediate Level 1 of the DOM tree 203 can include nodes “1.1” and “1.2,” and so on down to intermediate Level m, which can include nodes “m.1,” . . . , “m.n.” Each of the nodes m.1, . . . , m.n in Level m of the DOM tree 203 can have a plurality of leaf nodes. For example, in a leaf node level 250 of the DOM tree 203, the node m.1 may have a leaf node “1” and a leaf node “2,” and so on up to the node m.n, which may have a leaf node “n” and a leaf node “n+1.” Within the DOM tree 203, the leaf nodes 1, 2, . . . , n, n+1 in the leaf node level 250 can correspond to actual webpage content information, such as images, video, text, etc. Further, each of the nodes 0, 1.1, 1.2, . . . , m.1, . . . , m.n can be a parent (or ancestor) node of one or more child (or descendent) nodes. For example, (i) the root node 0 may be a parent node of child nodes 1.1, 1.2, (ii) the node 1.1 may be a parent node of at least the child node m.1, (iii) the node 1.2 may be a parent node of at least the child node m.n, (iv) the node m.1 may be a parent node of the child leaf nodes 1, 2, and (v) the node m.n may be a parent node of the child leaf nodes n, n+1. Each of the parent nodes 0, 1.1, 1.2, . . . , m.1, . . . , m.n can include associated structure information (e.g., positions, locations, dimensions, and/or sizes of UI elements) and style and/or format attributes for use in rendering the webpage 200.

As described herein, to detect overlap issues in the webpage 200, the detection script 228 can perform a recursive (e.g., top-down, bottom-up) traversal of the nodes of the DOM tree 203, traversing top-down starting from the root node 0 (or one of the parent nodes 1.1, 1.2, . . . , m.1, . . . , m.n) to the leaf nodes 1, 2, n, . . . , n+1, and traversing bottom-up from the leaf nodes 1, 2, . . . , n, n+1 back toward the root node 0 (or the parent node 1.1, 1.2, . . . , m.1, . . . , or m.n), taking into account both the left sub-tree 246 and the right sub-tree 248 of the DOM tree 203. During the top-down traversal of the DOM tree 203, the detection script 228 extracts or otherwise obtains at least the structure information (e.g., positions/dimensions of UI elements) from the parent nodes 0, 1.1, 1.2, . . . , m.1, . . . , m.n in the respective Levels 0-m, and stores the structure information for each parent node in a candidate list. During the bottom-up traversal of the DOM tree 203, the detection script 228 can determine, by analyzing (e.g., comparing) structure information (e.g., positions/dimensions) for pairs of UI elements from the candidate list, whether a UI element can overlap and either completely or partially cover another UI element in the webpage 200.

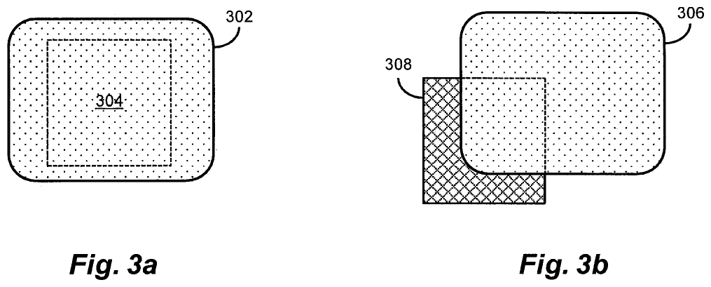

FIG. 3a illustrates, for demonstration purposes, a UI element 302 that overlaps and completely covers a UI element 304. In this example, because the UI element 302 completely covers the UI element 304, the UI elements 302, 304 would not be deemed to be indicative of an overlap layout issue for an exemplary webpage. FIG. 3b illustrates, for demonstration purposes, a UI element 306 that overlaps and partially covers a UI element 308. In this example, because the UI element 306 just partially covers the UI element 308, the UI elements 306, 308 would be deemed to be indicative of an overlap layout issue for the exemplary webpage. As shown in FIG. 2a, the UI element 216 pertaining to the XenApp/XenDesktop service overlaps and partially covers the UI element 218 in the webpage 200. In this example, the UI elements 216, 218 of FIG. 2a are therefore like the UI elements 306, 308 of FIG. 3b, and therefore would be deemed to be indicative of an overlap layout issue for the webpage 200.

During the bottom-up traversal of the DOM tree 203, once the detection script 228 determines, at an intermediate level 1, 2, . . . , or m of the DOM tree 203, that a UI element described by the structure information of a parent node overlaps and completely covers a UI element(s) described by the structure information of its child node(s), the bottom-up traversal of the DOM tree 203 can terminate at that intermediate level 1, 2, . . . , or m before reaching the root node 0, due to the structures of the respective elements not being indicative of an overlap layout issue for the webpage 200. Otherwise, if the detection script 228 determines, at an intermediate level 1, 2, . . . , or m of the DOM tree 203, that a UI element (such as the UI element 216; see FIG. 2a) described by the structure information of a parent node overlaps and partially covers a UI element(s) (such as the UI element 218; see FIG. 2a) described by the structure information of its child node(s), the bottom-up traversal of the DOM tree 203 can continue beyond the intermediate level 1, 2, . . . , or m, possibly ultimately terminating at the root node 0. Moreover, the structure information for the UI elements that are not indicative of an overlap layout issue for the webpage 200 are removed from the candidate list, while the structure information for the UI elements that are indicative of an overlap layout issue for the webpage 200 are maintained in the candidate list. Once the bottom-up traversal of the DOM tree 203 has terminated (at Level 0, or Level 1, 2, . . . , or m), the structure information for the UI elements that remain in the candidate list can be provided to a suspect element list for overlap layout issues, which lists the UI elements (and their associated structure information) having the detected overlap layout issues for the webpage 200.

In addition to detecting the “overlap” type of UI layout issues, the detection script 228 may be further executed to detect the “truncation” type of UI layout issues pertaining to the UI elements in the webpage 200. To detect such truncation issues in the webpage 200, the detection script 228 can perform the recursive (e.g., top-down, bottom-up) traversal of the nodes of the DOM tree 203, as described herein with reference to the overlap layout issues. However, during the bottom-up traversal of the DOM tree 203, the detection script 228 can determine, based on the structure information obtained from the parent nodes 0, 1.1, 1.2, . . . , m.1, . . . , m.n in the respective Levels 0-m, (i) whether a UI element (e.g., a hyperlink or text) has a width that is longer than the width of another UI element (e.g., a box) that contains the hyperlink or text, and (ii) whether a portion of the hyperlink or text is hidden from view within the box. One such truncation issue (as indicated by reference numeral 220) involves an image of the box 208, which contains an image of the hyperlink or text pertaining to an e-mail address of the selected administrator entity. As shown in FIG. 2a, the hyperlink or text, “E-mail address of en . . . ,” has a width that appears to be longer than the width of the box 208 that contains the hyperlink or text, as evidenced by a portion of the hyperlink or text, “E-mail address of en . . . ,” being hidden from view. The structure information for the box 208 and the hyperlink or text contained in the box 208 therefore provides an indication of a truncation layout issue for the webpage 200. Once the bottom-up traversal of the DOM tree 203 has terminated at the root node 0, the structure information for the UI elements corresponding to the box 208 and the hyperlink or text contained therein can be included in a suspect element list for truncation layout issues, which lists the UI elements (and their associated structure information) having the detected truncation layout issues for the webpage 200.

Having generated the suspect element lists for overlap and truncation layout issues, the client computer 104 (or a remote computer) performs functions or acts pertaining to the filtering phase 242 (see FIG. 2b). As illustrated in FIG. 2b, during the filtering phase 242, the client computer 104 (or a remote computer) further executes the code for detecting webpage UI layout issues 120 to perform the functions or acts of (i) generating one or more screenshots 232, (ii) performing image processing 234, and/or (iii) issuing a report 236 of UI layout issues for the webpage 200. Some or all of these functions or acts can be performed during the filtering phase 242 to remove false positive indications of UI layout issues from the respective suspect element lists.

In this example, the suspect element list for overlap layout issues lists the UI elements 216, 218 as having possible overlap layout issues in the webpage 200. To determine whether or not the UI elements 216, 218 correspond to false positive indications of overlap layout issues, the function of generating screenshots 232 can be performed, by the client computer 104 (or a remote computer), to generate a screenshot image of each of the UI elements 216, 218 (see FIG. 2a) in the webpage 200, using the structure information (e.g., positions/dimensions) for the UI elements 216, 218 maintained in the suspect element list for overlap layout issues. Having generated the screenshot images for the respective UI elements 216, 218, the function of image processing 234 can be performed, by the client computer 104 (or a remote computer), to determine, using the screenshot images for the UI elements 216, 218, whether or not the common region 223 (see FIG. 2a) of the overlapping UI elements 216, 218 corresponds to a transparent or blank image area.

If it is determined that the common region 223 corresponds to a transparent or blank image area, then the UI elements 216, 218 may be deemed to be false positive indications of overlap layout issues, because, in this case, the common region 223 would likely not obscure any visible (i.e., non-transparent or non-blank) portion(s) of the UI elements 216, 218 in the webpage 200. However, if it is determined that the common region 223 does not correspond to a transparent or blank image area, then the UI elements 216, 218 may not be deemed to be false positive indications of overlap layout issues, because the common region 223 would likely obscure a visible (i.e., non-transparent or non-blank) portion(s) of the UI elements 216, 218 in the webpage 200.

In this example, the suspect element list for truncation layout issues lists the UI element 208 (i.e., the box) and the hyperlink or text element (“E-mail address of en . . . ”) contained in the box 208 as having possible truncation layout issues in the webpage 200. To determine whether or not the box 208 and the hyperlink or text element contained in the box 208 correspond to false positive indications of truncation layout issues, the client computer 104 (or a remote computer) may modify the style and/or format attributes contained in a CSS file for the box 208 to make the image of the box 208 transparent (i.e., not visible) in the webpage 200. Having made the image of the box 208 transparent (i.e., not visible), the function of generating screenshots 232 can be performed, by the client computer 104 (or a remote computer), to generate a first screenshot image of the hyperlink or text element (“E-mail address of en . . . ”) in the webpage 200, using the structure information (e.g., position/dimension) for the hyperlink or text element maintained in the suspect element list for truncation layout issues. The client computer 104 (or a remote computer) may then modify the style and/or format attributes for the box 208 to make the image of the box 208 visible (i.e., non-transparent or non-blank) in the webpage 200, and generate a second screenshot image of the box 208 and the hyperlink or text element (“E-mail address of en . . . ”) contained in the box 208, using the structure information (e.g., positions/dimensions) for the box 208 and the hyperlink or text element maintained in the suspect element list for truncation layout issues. Having generated the first screenshot image and the second screenshot image, the function of image processing 234 can be performed, by the client computer 104 (or a remote computer), to analyze (e.g., compare) the first and second screenshot images to determine whether or not the two screenshot images are identical (or the same).

If it is determined that the first and second screenshot images are identical (or the same), then the box 208 and the hyperlink or text element contained in the box 208 may be deemed to be false positive indications of truncation layout issues, because, in this case, a visible (i.e., non-transparent or non-blank) portion of the hyperlink or text would likely not be hidden from view within the box 208 in the webpage 200. However, if it is determined that the first and second screenshot images are not identical (or not the same), then the box 208 and the hyperlink or text element contained in the box 208 may not be deemed to be false positive indications of truncation layout issues, because a visible (i.e., non-transparent or non-blank) portion of the hyperlink or text would likely be hidden from view within the box 208 in the webpage 200.

Once the UI elements deemed to be false positive indications of overlap or truncation layout issues have been identified, the function of issuing a report 236 of UI layout issues for the webpage 200 can be performed, by the client computer 104 (or a remote computer), to remove such UI elements from the suspect element lists for overlap/truncation layout issues, and to include any UI elements remaining in the suspect element lists for overlap/truncation layout issues in the client report 238 (see FIG. 2b) of UI layout issues for the webpage 200. The client computer 104 (or a remote computer) can then provide the client report 238 to the user in any suitable hardcopy or electronic format (e.g., text or screenshots), as well as highlight the UI layout issues for the webpage 200 on the display 117.

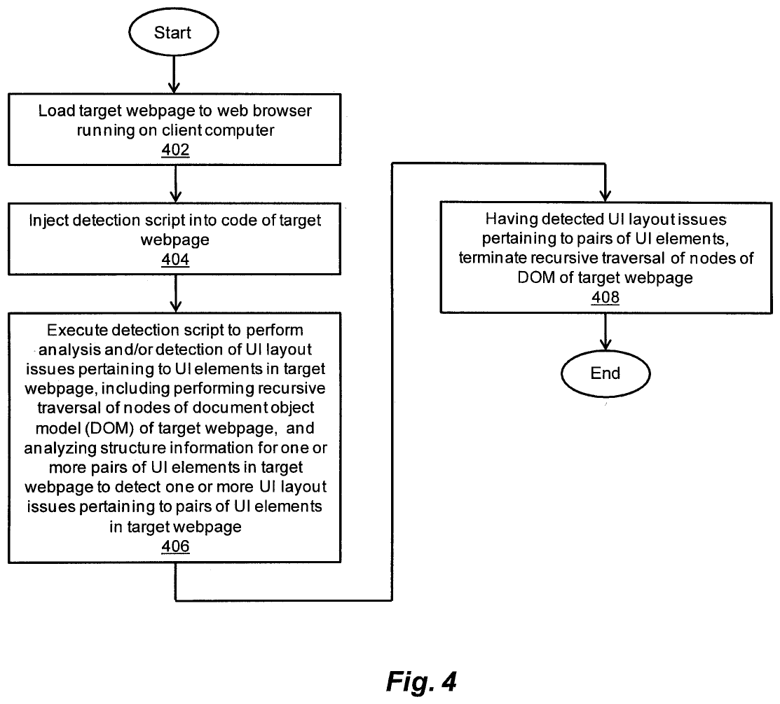

An exemplary method of detecting UI layout issues for web applications is described below with reference to FIG. 4. As depicted in block 402, a target webpage is loaded to a web browser running on a client computer. As depicted in block 404, a detection script is injected into code of the target webpage. As depicted in block 406, the detection script is executed to perform analysis and/or detection of UI layout issues pertaining to UI elements in the target webpage, including (i) performing a recursive traversal of nodes of a document object model (DOM) of the target webpage, and (ii) analyzing structure information for one or more pairs of UI elements in the target webpage to detect one or more UI layout issues pertaining to the pairs of UI elements in the target webpage. As depicted in block 408, having detected the UI layout issues pertaining to the pairs of UI elements, the recursive traversal of nodes of the DOM of the target webpage is terminated.

Having described the foregoing illustrative embodiments, other alternative embodiments and/or variations may be made and/or practiced. For example, it was described herein that a common region of two UI elements in a webpage, in which one UI element overlaps and partially covers another UI element, may not be deemed to be a false positive indication of an overlap issue if the common region does not correspond to a transparent or blank image area. In such a case, the common region would likely obscure a visible (i.e., non-transparent or non-blank) portion of one or more of the UI elements. In one embodiment, having determined that such a common region of partially overlapping UI elements in a webpage does not correspond to a transparent or blank image area, the disclosed techniques can automatically relocate at least one of the UI elements in the webpage so as to avoid obscuring a visible (i.e., non-transparent or non-blank) portion of the respective UI elements.

For example, the disclosed techniques may determine currently assigned positions/dimensions of the respective UI elements, as specified in a CSS file describing a UI presentation of the webpage. Further, during the filtering phase of the detection of UI layout issues for the webpage, the functions of generating screenshots (reference numeral 232; see FIG. 2b) and image processing (reference numeral 234; see FIG. 2b) can be performed to locate any transparent or blank portions of the respective UI elements, and to generate information pertaining to the locations of the transparent or blank portions. The disclosed techniques can then automatically reassign the position(s)/dimension(s) of one or more of the UI elements based on the location information for the transparent or blank portions of the UI elements so that a resulting common region of the partially overlapping UI elements corresponds to a transparent or blank image area, and update the CSS file for the webpage accordingly. If such transparent or blank portions of the respective UI elements cannot be located, then the disclosed techniques can automatically reassign the position(s)/dimension(s) of one or more of the UI elements to avoid any overlapping of the respective UI elements, and update the CSS file for the webpage accordingly. The disclosed techniques can also automatically provide suggestions for reassigning the position(s)/dimension(s) of one or more of the UI elements in the client report (reference numeral 238; see FIG. 2b) of UI layout issues.

It was further described herein that a container element (e.g., the box 208; see FIG. 2a) containing a hyperlink or text in a webpage may not be deemed to be a false positive indication of a truncation issue if a screenshot of a transparent image of the container element and the (non-transparent) hyperlink or text is not identical (or not the same as) a screenshot of a non-transparent image of the container element and the (non-transparent) hyperlink or text. In such a case, a visible (i.e., non-transparent or non-blank) portion of the hyperlink or text would likely be hidden from view within the container element in the webpage. In one embodiment, having determined that such a non-transparent or non-blank portion of a hyperlink or text would likely be hidden from view within its container element in a webpage, the disclosed techniques can automatically adjust the scale of at least one of the container element and the hyperlink or text so as to avoid obscuring a visible (i.e., non-transparent or non-blank) portion of the hyperlink or text in the webpage.

For example, during the filtering phase of the detection of UI layout issues for the webpage, the functions of generating screenshots (reference numeral 232; see FIG. 2b) and image processing (reference numeral 234; see FIG. 2b) can be performed to determine (i) an extent (e.g., length, area) of the container element and (ii) an extent (e.g., length, area) of the obscured visible (i.e., non-transparent or non-blank) portion of the hyperlink or text, and to generate information pertaining to the respective extents of the container element and the obscured hyperlink or text. The disclosed techniques can then automatically scale the extents (e.g., lengths, areas) of one or more of the container element and the hyperlink or text so that no portion of the hyperlink or text within the container element is obscured in the webpage, and update a CSS file for the webpage accordingly. The disclosed techniques can also automatically provide suggestions for scaling the extents (e.g., lengths, areas) of one or more of the container element and the hyperlink or text in the client report (reference numeral 238; see FIG. 2b) of UI layout issues.

Although features are shown and described herein with reference to particular illustrative embodiments of the disclosed techniques, such features may be included and are hereby included in any of the illustrative embodiments and their variants. Thus, it is understood that features disclosed in connection with any illustrative embodiment are included as variants of any other illustrative embodiment. Further, the disclosed techniques or portions thereof may be embodied as a computer program product including one or more non-transient, computer-readable storage media, such as a magnetic disk, magnetic tape, compact disk, digital versatile disk (DVD), optical disk, flash drive, solid state drive (SSD), secure digital (SD) chip or device, application specific integrated circuit (ASIC), field programmable gate array (FPGA), and/or the like. Any number of computer-readable media may be used. The media may be encoded with instructions that perform the process or processes described herein when executed on one or more computers, processors, or processing circuitry. Such media may be considered articles of manufacture or machines, and may be transportable from one machine to another.

As used throughout this document, the words “comprising,” “including,” “containing,” and “having” are intended to set forth certain items, steps, acts, elements, or aspects of something in an open-ended fashion. Further, as employed herein, the word “set” or “subset” means one or more of something. This is the case regardless of whether the phrase “set of or” subset of is followed by a singular or plural object, and regardless of whether it is conjugated with a singular or plural verb. In addition, although ordinal expressions such as “first,” “second,” “third,” and so on, may be used as adjectives herein, such ordinal expressions are used for identification purposes, and, unless specifically indicated, are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature, or act. Rather, the “first” item may be the only one. Although certain illustrative embodiments are disclosed herein, it is understood that these embodiments are provided by way of example, and that the disclosed techniques are not limited to these particular embodiments.

While various embodiments of the disclosure have been particularly shown and described, it will be understood by those skilled in the art that various changes in form and details may be made therein without departing from the scope of the disclosure, as defined by the appended claims.

What is claimed is:

1. A method of detecting user interface (UI) layout issues for web applications, comprising:
loading a target webpage to a web browser running on a client computer;
injecting a detection script into code of the target webpage;
executing the detection script to perform one or more of analysis and detection of UI layout issues pertaining to UI elements in the target webpage, the executing of the detection script including:
performing a recursive traversal of nodes of a document object model (DOM) of the target webpage, the nodes including at least structure information for rendering the respective UI elements in the target webpage; and
while performing the recursive traversal of nodes of the DOM, analyzing the structure information for one or more pairs of UI elements in the target webpage to detect one or more UI layout issues pertaining to the one or more pairs of UI elements in the target webpage; and
having detected the one or more UI layout issues pertaining to the one or more pairs of UI elements, automatically generating, in a client report, one or more suggestions for modifying at least some of the structure information to address one or more of the UI layout issues, and terminating the recursive traversal of nodes of the DOM of the target webpage.

2. The method of claim 1 wherein the one or more UI layout issues include one or more overlap layout issues, and wherein the analyzing of the structure information for one or more pairs of UI elements in the target webpage includes analyzing the structure information included in one or more nodes at an intermediate level of the DOM to detect the one or more overlap layout issues pertaining to the one or more pairs of UI elements in the target webpage.

3. The method of claim 2 wherein the one or more pairs of UI elements include a respective pair having a first UI element and a second UI element, wherein the one or more overlap layout issues include a respective overlap layout issue pertaining to the first UI element overlapping and completely covering the second UI element, and wherein the terminating of the recursive traversal of nodes of the DOM of the target webpage includes, having detected the respective overlap layout issue pertaining to the first UI element overlapping and completely covering the second UI element, terminating the recursive traversal of nodes of the DOM for detecting UI layout issues pertaining to the first and second UI elements at the intermediate level of the DOM, due to the respective overlap layout issue not being problematic in the target webpage.

4. The method of claim 2 wherein the one or more pairs of UI elements include a respective pair having a first UI element and a second UI element, wherein the one or more overlap layout issues include a respective overlap layout issue pertaining to the first UI element overlapping and partially covering the second UI element, and wherein the method further comprises:
having detected the respective overlap layout issue pertaining to the first UI element overlapping and partially covering the second UI element, continuing the recursive traversal of nodes of the DOM for detecting UI layout issues pertaining to the first and second UI elements to at least another level beyond the intermediate level of the DOM.

5. The method of claim 4 wherein the terminating of the recursive traversal of nodes of the DOM of the target webpage includes, having detected the respective overlap layout issue pertaining to the first UI element overlapping and partially covering the second UI element, terminating the recursive traversal of nodes of the DOM for detecting UI layout issues pertaining to the first and second UI elements at the other level beyond the intermediate level of the DOM.

6. The method of claim 1 wherein the one or more UI layout issues include one or more truncation layout issues, and wherein the analyzing of the structure information for one or more pairs of UI elements in the target webpage includes analyzing the structure information included in one or more nodes at an intermediate level of the DOM to detect the one or more truncation layout issues pertaining to the one or more pairs of UI elements in the target webpage.

7. The method of claim 6 wherein the one or more pairs of UI elements include a respective pair having a first UI element and a second UI element, wherein the second UI element is a container element that contains the first UI element, wherein the one or more truncation layout issues include a respective truncation layout issue pertaining to (i) a first width of the first UI element being longer than a second width of the second UI element, and (ii) a portion of the first UI element being hidden from view within the second UI element, and wherein the method further comprises:
having detected the respective truncation layout issue pertaining to the first UI element and the second UI element, continuing the recursive traversal of nodes of the DOM for detecting UI layout issues pertaining to the first and second UI elements to at least another level beyond the intermediate level of the DOM.

8. The method of claim 7 wherein the terminating of the recursive traversal of nodes of the DOM of the target webpage includes, having detected the respective truncation layout issue pertaining to the first UI element and the second UI element, terminating the recursive traversal of nodes of the DOM for detecting UI layout issues pertaining to the first and second UI elements at the other level beyond the intermediate level of the DOM.

9. A system for detecting user interface (UI) layout issues for web applications, comprising:
a memory; and
processing circuitry configured to execute instructions out of the memory:
to load a target webpage to a web browser;
to inject a detection script into code of the target webpage;
to execute the detection script to perform one or more of analysis and detection of UI layout issues pertaining to UI elements in the target webpage, wherein execution of the detection script includes:
performing a recursive traversal of nodes of a document object model (DOM) of the target webpage, the nodes including at least structure information for rendering the respective UI elements in the target webpage; and
while performing the recursive traversal of nodes of the DOM, analyzing the structure information for one or more pairs of UI elements in the target webpage to detect one or more UI layout issues pertaining to the one or more pairs of UI elements in the target webpage; and
having detected the one or more UI layout issues pertaining to the one or more pairs of UI elements, to automatically generate, in a client report, one or more suggestions for modifying at least some of the structure information to address one or more of the UI layout issues, and to terminate the recursive traversal of nodes of the DOM of the target webpage.

10. The system of claim 9 wherein the one or more UI layout issues include one or more overlap layout issues, and wherein the processing circuitry is further configured to execute the instructions out of the memory to analyze the structure information included in one or more nodes at an intermediate level of the DOM to detect the one or more overlap layout issues pertaining to the one or more pairs of UI elements in the target webpage.

11. The system of claim 10 wherein the one or more pairs of UI elements include a respective pair having a first UI element and a second UI element, wherein the one or more overlap layout issues include a respective overlap layout issue pertaining to the first UI element overlapping and completely covering the second UI element, and wherein the processing circuitry is further configured to execute the instructions out of the memory, having detected the respective overlap layout issue pertaining to the first UI element overlapping and completely covering the second UI element, to terminate the recursive traversal of nodes of the DOM for detecting UI layout issues pertaining to the first and second UI elements at the intermediate level of the DOM, due to the respective overlap layout issue not being problematic in the target webpage.

12. The system of claim 10 wherein the one or more pairs of UI elements include a respective pair having a first UI element and a second UI element, wherein the one or more overlap layout issues include a respective overlap layout issue pertaining to the first UI element overlapping and partially covering the second UI element, and wherein the processing circuitry is further configured to execute the instructions out of the memory, having detected the respective overlap layout issue pertaining to the first UI element overlapping and partially covering the second UI element, to continue the recursive traversal of nodes of the DOM for detecting UI layout issues pertaining to the first and second UI elements to at least another level beyond the intermediate level of the DOM.

13. The system of claim 12 wherein the processing circuitry is further configured to execute the instructions out of the memory, having detected the respective overlap layout issue pertaining to the first UI element overlapping and partially covering the second UI element, to terminate the recursive traversal of nodes of the DOM for detecting UI layout issues pertaining to the first and second UI elements at the other level beyond the intermediate level of the DOM.

14. The system of claim 9 wherein the one or more UI layout issues include one or more truncation layout issues, and wherein the processing circuitry is further configured to execute the instructions out of the memory to analyze the structure information included in one or more nodes at an intermediate level of the DOM to detect the one or more truncation layout issues pertaining to the one or more pairs of UI elements in the target webpage.

15. The system of claim 14 wherein the one or more pairs of UI elements include a respective pair having a first UI element and a second UI element, wherein the second UI element is a container element that contains the first UI element, wherein the one or more truncation layout issues include a respective truncation layout issue pertaining to (i) a first width of the first UI element being longer than a second width of the second UI element, and (ii) a portion of the first UI element being hidden from view within the second UI element, and wherein the processing circuitry is further configured to execute the instructions out of the memory, having detected the respective truncation layout issue pertaining to the first UI element and the second UI element, to continue the recursive traversal of nodes of the DOM for detecting UI layout issues pertaining to the first and second UI elements to at least another level beyond the intermediate level of the DOM.

16. The system of claim 15 wherein the processing circuitry is further configured to execute the instructions out of the memory, having detected the respective truncation layout issue pertaining to the first UI element and the second UI element, to terminate the recursive traversal of nodes of the DOM for detecting UI layout issues pertaining to the first and second UI elements at the other level beyond the intermediate level of the DOM.

17. A computer program product including non-transitory, computer-readable media having instructions that, when executed by processing circuitry of a computerized apparatus, cause the processing circuitry to perform a method of detecting user interface (UI) layout issues for web applications, the method comprising:
loading a target webpage to a web browser running on a client computer;
injecting a detection script into code of the target webpage;
executing the detection script to perform one or more of analysis and detection of UI layout issues pertaining to UI elements in the target webpage, the executing of the detection script including:
performing a recursive traversal of nodes of a document object model (DOM) of the target webpage, the nodes including at least structure information for rendering the respective UI elements in the target webpage; and
while performing the recursive traversal of nodes of the DOM, analyzing the structure information for one or more pairs of UI elements in the target webpage to detect one or more UI layout issues pertaining to the one or more pairs of UI elements in the target webpage; and
having detected the one or more UI layout issues pertaining to the one or more pairs of UI elements, automatically generating, in a client report, one or more suggestions for modifying at least some of the structure information to address one or more of the UI layout issues, and terminating the recursive traversal of nodes of the DOM of the target webpage.

18. The method of claim 17 wherein the one or more UI layout issues include one or more overlap layout issues, and wherein the analyzing of the structure information for one or more pairs of UI elements in the target webpage includes analyzing the structure information included in one or more nodes at an intermediate level of the DOM to detect the one or more overlap layout issues pertaining to the one or more pairs of UI elements in the target webpage.

19. The method of claim 18 wherein the one or more pairs of UI elements include a respective pair having a first UI element and a second UI element, wherein the one or more overlap layout issues include a respective overlap layout issue pertaining to the first UI element overlapping and completely covering the second UI element, and wherein the terminating of the recursive traversal of nodes of the DOM of the target webpage includes, having detected the respective overlap layout issue pertaining to the first UI element overlapping and completely covering the second UI element, terminating the recursive traversal of nodes of the DOM for detecting UI layout issues pertaining to the first and second UI elements at the intermediate level of the DOM, due to the respective overlap layout issue not being problematic in the target webpage.

20. The method of claim 17 wherein the one or more UI layout issues include one or more truncation layout issues, and wherein the analyzing of the structure information for one or more pairs of UI elements in the target webpage includes analyzing the structure information included in one or more nodes at an intermediate level of the DOM to detect the one or more truncation layout issues pertaining to the one or more pairs of UI elements in the target webpage, wherein the one or more pairs of UI elements include a respective pair having a first UI element and a second UI element, wherein the second UI element is a container element that contains the first UI element, wherein the one or more truncation layout issues include a respective truncation layout issue pertaining to (i) a first width of the first UI element being longer than a second width of the second UI element, and (ii) a portion of the first UI element being hidden from view within the second UI element, wherein the method further comprises:
having detected the respective truncation layout issue pertaining to the first UI element and the second UI element, continuing the recursive traversal of nodes of the DOM for detecting UI layout issues pertaining to the first and second UI elements to at least another level beyond the intermediate level of the DOM, and
wherein the terminating of the recursive traversal of nodes of the DOM of the target webpage includes, having detected the respective truncation layout issue pertaining to the first UI element and the second UI element, terminating the recursive traversal of nodes of the DOM for detecting UI layout issues pertaining to the first and second UI elements at the other level beyond the intermediate level of the DOM.
